(19) United States
(12) Patent Application Publication
(10) Pub. No.: US 2005/0060561 A1
(43) Pub. Date: Mar. 17, 2005

(54) Protection of data

(76) Inventors: Siani Lynne Pearson, Whitebrook Llanvaches (GB); Yolanta Beresnevichiene, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/894,678

(22) Filed: Jul. 20, 2004

(30) Foreign Application Priority Data
Jul. 31, 2003 (GB) 0317936.3

(51) Int. Cl. H04L 9/00

(52) U.S. Cl. 713/194

(57) ABSTRACT

A method of protecting a user's data comprises: a) wrapping data content to be sent to a third party computing platform in a compound software wrapper; b) interrogating the third party computing platform for compliance with a trusted platform specification; c) on successful interrogation of the third party computing platform, transmitting the data content wrapped in the compound wrapper to the third party computing platform; d) unwrapping the compound software wrapper on the third party computing platform; e) wherein the third party computing platform treats the data content in conformity with a compound policy forming part of the software wrapper which compound policy specifies how the data content may be used.

This invention relates to a method of protecting a user's data, a method of wrapping data content in a compound software wrapper, a method of using data on a third party computing platform, a compound software wrapper, and a computer platform.

The central problem addressed is how a user can trust unknown infrastructure with their private data. Business scenarios are increasingly emerging where computer users ‘free-seat’ or ‘hot-desk’ within corporate offices, borrow partners' computers when working on their sites or even work on company-sensitive information or input personal data within public terminals. For example, a business user might want to update his/her PowerPoint (TM) presentation or send a sensitive email whilst waiting for a flight at an airport terminal, at a public terminal there. Or a holidaymaker might want to catch up with some on-line shopping bargains, send flowers to a relative or brush up on learning Italian, on the same terminal. In both cases, the users would require assurances that information about who they are and what they are doing is not being stored on the computer, and in particular, that their personal or sensitive information is not open to storage and abuse (for example, unauthorised forwarding to other machines either for profiling or fraud). Furthermore, they may wish to make use of applications for which they are licensed already. On the other hand, technology is not available today that can provide all the requisite guarantees, both to the user and to the owners of any proprietary content that may be accessed.

For the mobile user, storage of credentials on a tamper-resistant trusted device/token (together with inputting a PIN or biometric information when required) can prove identity or attributes (e.g. role-based credentials) and allow access to applications and content for which the holder is registered, and this is a convenient way of authentication. Authorisation mechanisms are already in existence that utilise such tokens. Licensing models that exist centre around restricting usage of applications or images on a given platform, but could be extended to models that allow users to access potentially sensitive data (e.g. corporate information) by checking the credentials on these tokens. Either the information could be contained on the card itself and transferred temporarily to the machine (as would be the case with proof of possession of certain attributes, or documents, presentations etc), or the card could just contain credentials that would allow the holder to access such information (for example, accessing a corporate VPN to read email, or using—and possibly first downloading—applications on the platform which they are authorised/licensed to use). Due to cost-constraints and the limited space on such tokens, it is likely that any generic solution would have to allow for the latter as well as the former. A special case is that of payment credentials, which may be anonymous (cf. e-cash) or closely tied to the user (credit card numbers).

Software wrapper technology such as IBM's Cryptolope, InterTrust's Digibox, Adobe Web Merchant and eBook are relatively inexpensive and convenient, and hence suited to low-cost software distributed by electronic means. However, it is less secure than hardware-based methods of protection. It doesn't solve the problem of protecting users' or corporate sensitive data and credentials, nor of ensuring that users' wishes are enforced regarding how their data or personal information is used.

Software wrappers are of two main types:
The first, the non-invasive type, is the most commonly used. Non-invasive wrappers are digital envelopes wrapped around an unmodified software product (i.e. the same product as used in traditional distribution) to protect against unauthorised use. Customers are allowed to download the product, but prevented by the wrapper from unlocking the product until payment is received. The wrappers can also ensure that the file has not been tampered with before executing the program, and screen against viruses and hacking attempts.
The second type of wrapper is the invasive wrapper. Developers have to insert code into their products to launch the wrapper's user registration validation scheme. Each time the product is executed, the wrappers generate an appropriate billing. New selling models are possible, such as rental, try-before-you-buy and metered sales of software.

The internal content of wrappers varies, but the more secure types of wrapper would typically include the following sub-components:
First, there would be an overview of the remainder of the wrapper. This would include a digital signature of the preceding records. This is to help detect if wrapper contents have been deleted.
There might also be a text description of the content;
Content files would be encrypted (for example using a bulk cipher key algorithm);
A key record: for each encrypted file, a key record is created and placed in this file. When a content file is encrypted, the symmetric key used in that encryption is itself encrypted, using public key cryptography. To do this, the clearing centre generates a public/private key pair, and communicates the public key half of this pair to the distributor, who then encrypts the symmetric key with the public key. The encrypted key and the ID of the public key used to encrypt it are then recorded in the key record along with the name of the encrypted file.
rights management language (which gives the terms of purchase of the content);
fingerprinting/watermarking. This is used to reduce unauthorised copying of intellectual property by adding identifying information to the content. If the added information is visible, it is called a watermark, and usually appears as a background pattern identifying the owner of the content; if invisible, it is called a fingerprint, and records the identity of the purchaser or distributor. Fingerprints allow tracking of the path of unauthorised distribution, if this should occur;
Digital certificates. The public key in the certificate is used to authenticate the wrapper by checking the digital signature in the ‘overview’ file.

In addition, anonymity can be provided using software wrapper technology for the mobile user, even in scenarios where properties of the user need to be shown to gain access. In contrast digital certificates used within tokens such as smart cards, which are increasingly being adopted as a solution to mobile authentication and authorisation, are not as good for ensuring user's anonymity. A digital certificate is a collection of information that has been digitally signed by some authority that is recognized and trusted by some community of certificate users. They vouch for the authenticity of a user's claimed identity: one of the most important types of certificate is a public-key certificate, or identity certificate, in which a public-key value is securely associated with a particular person, device, or other entity. Alternatively, a recognized authority can issue an authorisation certificate declaring that a particular person or thing possesses particular privileges or authority. A public-key certificate is digitally signed by a person or entity, called a Certification Authority (CA), which has confirmed the identity or other attributes of the holder (person, device or other entity) of the corresponding private key. The X.509 certificate framework is the best-known example of identity certificates. X.509v3 greatly improved the flexibility of such certificates by providing a generic mechanism to extend certificates in a standardised fashion, and by allowing the use of local names in certificates. However, various privacy-problems are associated with digital certificates, notably the following:
Each digital certificate can be traced uniquely to the person (or device) to whom it has been issued, which opens the possibility of tracking and compilation of dossiers detailing information about people and their behaviour.
Digital certificates can be misused to block service access to the holder, for example via the use of certificate blacklists.

Further information relating to Trusted Computing Platforms (TCP) can be found in “Trusted Computer Platforms: TCPA Technology in context”, July 2002, Prentice Hall PTR (ISBN 0-13-009220-7).

More information concerning data tagging can be found in two co-pending applications, GB applications 0301777.9 and 0301779.5, annexed hereto as Annex 1 and Annex 2 respectively.

A Trusted Platform is a computing platform that has a trusted component, probably in the form of built-in hardware, which it uses to create a foundation of trust for software processes. The computing platforms listed in the Trusted Computing Platform Alliance (TCPA) specification (htti://www.trustedcomputing.orgtcpaasp4/specs.asp) are one such type of Trusted Platform. Although different types of Trusted Platforms could be built, by way of example we concentrate in particular on the (version 1.1) instantiation specified by the TCPA industry standard.

Converting a platform into a Trusted Platform involves extra hardware roughly equivalent to that of a smart card, with some enhancements.

At present, secure operating systems use different levels of hardware privilege to logically isolate programs and provide robust platform operation, including security functions.

Converting a platform into a Trusted Platform requires that TCPA roots of trust be embedded in the platform, enabling the platform to be trusted by both local and remote users. In particular, cost-effective security hardware acts as a root of trust in Trusted Platforms. This security hardware contains those security functions that must be trusted. The hardware is a root of trust in a process that measures the platform's software environment. In fact, it could also measure the hardware environment, but the software environment is important because the primary issue is knowing what the computing engine is doing. If the software environment is found to be trustworthy enough for some particular purpose, all other security functions-and ordinary software-can operate as normal processes. These roots of trust are core TCPA capabilities.

Adding the full set of TCPA capabilities to a normal, non-secure platform gives it some properties similar to that of a secure computer with roots of trust. The resultant platform has robust security capabilities and robust methods of determining the state of the platform. Among other things, it can prevent access to sensitive data (or secrets) if the platform is not operating as expected. Adding TCPA technology to a platform doesn't change other aspects of platform robustness, so a non-secure platform that's enhanced in the way described above is not a conventional secure computer and probably not as robust as a secure platform that's enhanced in the same way.

Nevertheless, we believe that the architectural changes proposed in the TCPA specification are the cheapest way to enhance security in an ordinary, non-secure computing platform. The architectural cost of converting a secure platform into a Trusted Platform is even less, because it requires fewer TCPA functions.

Any type of computing platform-for example, a PC, server, personal digital assistant (PDA), printer, or mobile phone)-can be a Trusted Platform. A Trusted Platform is particularly useful as a connected and/or physically mobile platform, because the need for stronger trust and confidence in computer platforms increases with connectivity and physical mobility. In addition to threats associated with connecting to the Internet, such as the downloading of viruses, physical mobility increases the risk of unauthorized access to the platform-including actual theft. Trusted Platform technology provides mechanisms that are useful in both circumstances.

The first Trusted Platforms containing the new hardware will be desktop or laptop PCs. They'll protect secrets-keys that encrypt files and messages, keys that sign data, and authorization data-using access codes, binding of secrets to a particular physical platform, digital signing using those secrets, plus mechanisms and protocols to ensure that a platform has loaded its software properly. Later, Trusted Platforms will provide more advanced features such as protection of secrets depending on the software that's loaded (for instance, preventing a secret from being accessed if unknown software has been loaded on the platform, such as hacker scripts) and attestation identities for e-services. The technology is certain to evolve in the coming years.

Applications and services that would, benefit from using Trusted Platforms include electronic cash, email, hot-desking (allowing mobile users to share a pool of computers), platform management, single sign-on (enabling the user to authenticate himself or herself just once when using different applications during the same work session), virtual private networks, Web access, and digital content delivery. The functions of the security hardware are relatively benign as far as product export/import regulations are concerned, and all contentious security functions are implemented as security software and can be changed as required for individual markets.

Another important Trusted Platform property is that the functions of the security hardware operate on small amounts of data, permitting acceptable levels of performance even though the hardware is low cost. In contrast, the normal platform processor is used by a Trusted Platform's security software to manipulate large amounts of data and, as a result, to take advantage of the excellent price-to-performance ratio of normal computer platforms.

Determining the integrity of a platform-trusting a platform-is a critical feature of a Trusted Platform. Security mechanisms (processes or features) are used to provide the information needed to deduce the level of trust in a platform. Only the user who wants to use the platform can make the decision whether to trust the platform. The decision will change according to the intended use of the platform, even if the platform remains unchanged. The user needs to rely on statements by trusted individuals or organizations about the proper behaviour of a platform. This aspect ultimately differentiates a Trusted Platform from a conventional secure computer.

The Trusted Computing Platform Alliance has published documents that specify how a Trusted Platform must be constructed. Within each Trusted Platform is a Trusted (Platform) Subsystem, which contains a Trusted Platform Module (TPM), a Core Root of Trust for Measurement (CRTM), and support software (the Trusted platform Support Service or TSS). The TPM is a hardware chip that's separate from the main platform CPU(s). The CRTM is the first software to run during the boot process and is preferably physically located within the TPM, although this isn't essential. The TSS performs various functions, such as those necessary for communication with the rest of the platform and with other platforms. The TSS functions don't need to be trustworthy, but are nevertheless required if the platform is to be trusted. In addition to the Trusted Subsystem in the physical Trusted Platform, Certification Authorities (CAs) are centrally involved in the manufacture and usage of Trusted Platforms (TPs) in order to vouch that the TP is genuine.

Basic Functionalities of a Trusted Platform

A Trusted Platform is a normal open computer platform that has been modified to maintain privacy. It does this by providing the following basic functionalities:
A mechanism for the platform to show that it's executing the expected software
A mechanism for the platform to prove that it's a Trusted Platform while maintaining anonymity (if required)
Protection against theft and misuse of secrets held on the platform

We'll consider each of these requirements in turn.

Integrity Measurement and Reporting

Starting from a root of trust in hardware, a Trusted Platform performs a series of measurements that record summaries of software that has executed (or is executing) on a platform. Starting with the CRTM, there's a boot-strapping process by which a series of Trusted Subsystem components measure the next component in the chain (and/or other software components) and record the value in the TPM. By these means, each set of software instructions (binary code) is measured and recorded before it's executed. Rogue software cannot hide its presence in a platform because, after it's recorded, the recording cannot be undone until the platform is rebooted. The platform uses cryptographic techniques to communicate the measurements to an interested party, so the recorded values cannot be changed in transit.

Creation of Trusted Identities

It remains, therefore, to prove that the measurements were made reliably. This is the same as proving that a platform is a genuine Trusted Platform. That proof is provided by cryptographic attestation identities. Each identity is created on the individual Trusted Platform, with attestation from a Public Key Infrastructure (PKI) Certification Authority (CA). Each identity has a randomly generated asymmetric cryptographic key and an arbitrary textual string used as an identifier for the pseudonym (chosen by the owner of the platform). To obtain attestation from a CA, the platform's owner sends the CA information that proves that the identity was created by a genuine Trusted Platform. This process uses signed certificates from the manufacturer of the platform and uses a secret installed in the new (in the sense of unique) hardware in a Trusted Platform; that is, the Trusted Platform Module (TPM). That secret is known only to the Trusted Platform and is used only under control of the owner of the platform. That secret never needs to be divulged to arbitrary third parties; the cryptographic attestation identities are used for such purposes.

Protected Storage

A TPM is a secure portal to potentially unlimited amounts of protected storage, although the time to store and retrieve particular information could eventually become large. The portal is intended for keys that encrypt files and messages, keys that sign data, and for authorization secrets. For example, a CPU can obtain a symmetric key from a TPM and use it for bulk encryption, or can present data to a TPM and request the TPM to sign that data. The portal operates as a series of separate operations on individual secrets. Together, these operations make a tree (hierarchy) of TPM protected objects (also referred to in the TCPA specification as “blobs of opaque information,” which could either be “key blobs” or “data blobs”), each of which contains a secret encrypted (“wrapped”) by the key above it in the hierarchy. But the TPM knows nothing of this hierarchy. It's simply presented with a series of commands from untrusted software that manages the hierarchy.

An important feature that's peculiar to Trusted Platforms is that a TPM protected object can be “sealed” to a particular software state in a platform. When the TPM protected object is created, the creator indicates the software state that must exist if the secret is to be revealed. When a TPM unwraps the TPM protected object (within the TPM and hidden from view), the TPM checks that the current software state matches the indicated software state. If they match, the TPM permits access to the secret. If they don't match, the TPM denies access to the secret.

According to a first aspect of the invention a method of protecting a user's data comprises:
a) wrapping data content to be sent to a third party computing platform in a compound software wrapper;
b) interrogating the third party computing platform for compliance with a trusted platform standard;
c) on successful interrogation of the third party computing platform, transmitting the data content wrapped in the compound wrapper to the third party computing platform;
d) unwrapping the compound software wrapper on the third party computing platform;
e) wherein the third party computing platform treats the data content in conformity with a compound policy forming part of the software wrapper which compound policy specifies how the data content may be used.

Advantageously, a user can check the integrity of a third party computing platform that he wishes to use and also ensure that data sent to the third party platform is treated as specified by the user. The invention proposes to enhance software wrapper technology to solve the following problems: data and credentials may be safely transferred from a token to a new platform, and also downloaded onto the new platform, to be made use of by a mobile user in a safe and authorised manner in such a manner that the user's privacy is not infringed.

The solution uses Trusted Computing Platform Alliance (TCPA) technology in conjunction with operating system (OS) data tagging features.

The compound policy is preferably stored on a security token. The security token is preferably a tamper resistant smartcard.

The third party computing platform is preferably a computing platform owned or controlled by an entity independent from the user.

It should be noted that a reference to a trusted platform may be a reference to a computing platform compliant with the Trusted Computing Platform Alliance (TCPA) specification or may be a reference to another type of trusted platform such as Microsoft's Palladium/NGSCB.

The data content may be computer files, such as executable code including applications, user credentials, data files, including email files etc.

The compound policy may include a rights management policy, which preferably specifies terms of purchase of the data content, in the situation where the data is proprietary, such as a computer application, for example a word processing application, email application or spreadsheet application.

The compound policy may include at least one information flow control policy, which may be specified by a producer of the content, such as the user, which information flow control policy/policies define how the data content may be manipulated.

The compound policy may include a user privacy policy, which may specify circumstances in which the data content may be used. The user privacy policy preferably puts constraints on usage of the data content in addition to those specified in either or both of the rights management policy or the information flow control policy.

The compound policy preferably includes at least one of the rights management policy, the information flow control policy and/or the user privacy policy.

Advantageously, the provision of the compound policy with contents specified as above allows a user to define how his data content is handled by the third party computing platform.

The information flow control policy may specify that a user's data must be kept secret, preferably both during and after use.

The information flow control policy may specify whether the data content can be sent from the third party platform; printed; saved; copied; displayed one screen; allowed to leave a trusted area of the third party platform; deleted after a user's session with the third party platform has ceased, whether it is allowed to control printing, be-displayed on a screen and/or copied to a recordable medium. The user privacy policy may specify that the data content must be deleted or made otherwise unusable in specified circumstances, such as the platform or user attempting an unauthorised use of the data content

The compound wrapper may have a structure whereby a header precedes the user privacy policy, which preferably precedes a header from a provider of the data content, which preferably precedes encrypted data content. The encrypted data content may be preceded by an encrypted name of the data content and/or a digital signature by the content provider of a hash of the data content.

After unwrapping of the compound software wrapper, the method preferably includes associating a label with the data content, preferably the label is associated permanently with the data content. Preferably, the association of label to data content is enforced by an operating system (OS) on the third party platform.

The label preferably represents the compound policy/policies and preferably is used to ensure enforcement of policies thereof.

Advantageously, the use of data labelling and tagging allows the data content and use thereof to be controlled. The use of the data tagging at a level of the OS ensures software application-independent control and reduces the likelihood of circumvention of the compound policy/policies.

According to a second aspect of the invention a method of wrapping data content in a compound software wrapper comprises step a) of the first aspect, in which the compound software wrapper includes at least one of a rights management policy, an information flow control policy and a user privacy policy.

According to a third aspect of the invention a method of using data on a third party computing platform comprises steps d) and e) of the first aspect.

The method preferably includes the generation of a label that represents the compound policy/policies, which label is associated, preferably permanently, with the data content.

According to a fourth aspect of the invention a compound software wrapper comprises:
a header section relating to the content of the wrapper;
data content;
a key record section;
characterised by including a compound policy including one or more of a rights management policy, an information flow control policy and a user privacy-policy.

The compound policy/policies advantageously allow a user to control the use of his data by a third party computing platform that he wishes to use, and to which he wishes to transfer data in the knowledge that it will be used as he specifies.

The key record section may include key records for some or all of the data content.

The user privacy policy preferably further restricts the use of the data content allowed by the information flow control policy and/or the rights management policy.

According to a fifth aspect of the invention there is provided a recordable medium bearing a software wrapper according to the fourth aspect.

According to a sixth aspect of the invention recordable medium carrying at least a compound policy according to the first aspect.

Preferably the recordable medium is a smartcard. The recordable medium may be part of a Personal Digital Assistant (PDA). The recordable medium may be tamper resistant.

According to a seventh aspect of the invention a computer platform is operable to produce a compound software wrapper as defined in fourth aspect.

According to a eighth aspect of the invention a computer program product is operable to produce a compound software wrapper as defined in the fourth aspect.

According to a ninth aspect of the invention a computer platform is operable to unwrap a compound software wrapper as defined in the fourth aspect.

All of the features described herein may be combined with any of the above aspects, in any combination.

For a better understanding of the invention and to show how the same may be brought into effect, specific embodiments of the invention will now be described, by way of example, and with reference to the accompanying drawing, in which:

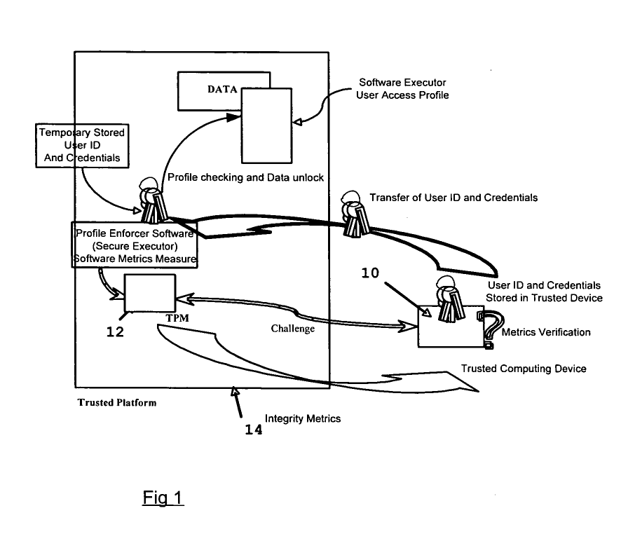

FIG. 1 is a schematic diagram showing components and interactions between components for protecting a user's data.

The data content is first wrapped to include a label and protection policies associated with that label. These protection policies can be set by the data producer, owner or user, but are defined in such a way that the user can only further extend any usage restrictions specified by the data producer (to avoid the user allowing access to the data in circumstances that contravene the data producers' policy). When the data is downloaded to a third party's platform, the label and associated policies are loaded into the operating system kernel, thus protecting them from any further modifications by rogue applications or other users. Once this is done, the data-tagging mechanism ensures that the label stays with the protected content and that the policies are enforced.

A default user policy may be applied (for example, by an agent acting on behalf of the user from a generic user privacy policy) that can be amended by the user for each data, if required. More information concerning these policies can be found in the applicants co pending application GB 0301777.9, which is annexed hereto as Annex 1. Such a policy would dictate the circumstances within which the user's private information would be made accessible from the token to a platform. For example, credit card information might only be given if the platform could prove it would store this information safely, was in a sufficiently trustworthy state and would delete the information once the user logged out. Another example would be that access to credentials for corporate access would only be allowed if the platform could prove it was a TCPA trusted platform in a trustworthy state, and again that credential-related information on the platform would be deleted after the authorised use.

In summary, the main features of the proposed system are that:
(1) Users' stipulations about data (e.g. content, attributes, credit card details, etc.) disclosure or usage and privacy policies are stored on, security tokens; mechanisms enforce that such data can be used only in accordance with these, and are destroyed after legitimate use.
(2) A ‘compound’ software wrapper keeps private information safe as well as being able to protect the rights of content-producers.
(3) The identity of the mobile user can be kept secret.
(4) All data received during the session can be kept secret.

In particular, TCPA and data tagging can be used to strengthen security and provide enforcement mechanisms within the proposed system:
(1) TCPA can be used to check that the underlying OS on the third party's platform supports data tagging
(2) The TPM can keep secrets secure
(3) The OS can be trusted to enforce the users' and data owners' policy regarding permitted transfers of data to local storage devices, local peripherals, and other machines on the network
(4) TCPA and the OS can be used to enforce mobile users' stipulations as to the circumstances in which their content may be used, including checking that the platform is not hacked before their content is accessed
(5) TCPA and the OS can enforce users' privacy policies with respect to data sensitivity and how it is protected, e.g. how and where data is stored or used (for example, run in a separate hardware compartment)

The system and method are implemented as described below.

Mobile users often need to download proprietary data on a third party's platform, such as in a cafe or airport. This data would be mostly stored on a portable trusted device (TD) belonging to the user such as a (tamper proof) smart card or trusted Personal Digital Assistant (PDA). A reference to a trusted device in this example applies to a device compliant with the TCPA specification (see www.trustedcomputing.org/tcpaasp4/specs.asp). However a trusted device may also comply with other specifications having a similar trusted status, such as Microsoft's Palladium/NGSCB. To protect the data from misuse once it is on the third party's platform the data is wrapped using a software wrapper mechanism together with a security label and policy before being sent to the third party platform. This policy controls how data would be printed out, copied or modified on a third party's platform. The solution also requires a Trusted Platform Module (TPM) to be present on the third party's platform (such a platform is called a Trusted Platform).

On the platform there will be a secure loader (that controls whether or not to download the data) and trusted executor software (that controls using the data on that platform), combined/merged with a trusted application policy (that controls whether or not to forward on the data). All this software is protected by means of an extension to the TCPA boot integrity checking process. Thus, the secure reader is part of the trusted environment.

On the trusted device each data (e.g. credentials or application to be protected) will be wrapped in a compound software wrapper that includes the software executor, the label and the user's privacy requirements concerning this data.

The compound wrapper is constructed by taking either any original wrapper put by a software provider or any credential information that needs to be protected. This is nested within another wrapper produced by the user or otherwise extended by the user or an agent of the user to create a compound wrapper, within which there is:
1. A header that includes an overview of the remainder of the wrapper, a digital signature of the following records (made by each party extending the wrapper—this is to help detect if wrapper contents have been deleted) and/or hash of the content (possibly encrypted) (this is used to bind the header to the encrypted content), and a text description/name of the content
2. The encrypted content files and/or credentials, using a bulk cipher key algorithm S for large data structures for example
3. A key record for each encrypted file. When a content file is encrypted, the symmetric key used in that encryption is itself encrypted, using public key cryptography. The encrypted key and the ID of the public key used to encrypt it are then recorded in the key record along with the name of the encrypted file
4. A compound policy specifying how the content/credentials may be used
5. Digital certificates. The public key in the certificate is used to authenticate the wrapper by checking the digital signature in the header. If multiple parties are involved in producing the compound wrapper, there will be multiple corresponding digital certificates.

Of the above the content files (2) are of course essential, because they are the purpose of the package.

The key records (3) may not be included for each encrypted file, since some files may not be used with each package, if only some data is to be used. The compound policy (4) is important. The digital certificates may be sent separately and so may be omitted from the compound wrapper.

The compound policy is composed of:
1. Rights management policy specifying the terms of purchase of the content, if appropriate
2. Information flow control policies specified by the content producer that define how content files/credentials can be manipulated, as described in Annex 1.
3. User privacy policy specifying the privacy-related circumstances in which the content/credentials can be used. This policy will further restrict the content usage, as it will be interpreted as restriction to policies (1) and (2).

Note that one or more of these components may be null. Typically, the compound policy will be constructed time wise in the order 1.-3., potentially involving several parties. As we have seen, rather than just extensions to the policy per se, the structure of the whole wrapper may need to be modified to reflect the compound nature of the wrapper.

As an example, the structure of the compound wrapper could be the following:
{header by user (including digital signature by user of the most important following records), privacy policy by user regarding how content may be used, header by content provider, encrypted name of content (by key S), digital signature by content provider of hash of content, encrypted content (by key S)}

The policy by the content provider regarding how content may be used—if applicable—could be contained within such a structure, or else could be specified in a separate license. The corresponding electronic licence would contain the name of the content, a list of access permissions and the secret key needed to decipher the encrypted content. The access permissions may require that the license to be signed by the data owner or by other parties. The license may contain or require other licenses or digital certificates. For this example, the structure of the corresponding electronic license could be:
{Plaintext name of content, encrypted by key W [name of content+licence version, access rights (e.g. read access, write permissions, execute permissions, other required licences and certificates), the secret key S, auxiliary information e.g. identity of TD or user]}

If the licence is separate, this brings benefits for the developer in that the wrapped encrypted data can be generic and generally available, and it is just the licence that needs to be tailored to an individual. Note for example that registration alone, or in addition checking for the presence of a pre-registered key or ID (e.g. TCPA key or identity), could allow release of the decryption key corresponding to W, and hence S. This information is contained within the licence. Obviously, in many circumstances it will not be appropriate for a licence produced by a third party to be associated with the software wrapper since the user wholly owns the content. Optionally, the user could themselves generate a licence in this manner that would specify privacy access conditions, such that data or credentials owned wholly by the user could be pre-wrapped in a generic way and then users could generate licences corresponding to this information, which could be tied to particular machines (used temporarily by the user, for example) or used in particular circumstances to govern usage of their data or personal information in accordance with the user's wishes.

The data owner (e.g. software producer, or agent acting on behalf of the user) can encrypt the content that is to be protected, and digitally sign and bind a wrapper to this encrypted content (this may match a licence created by the data owner that contains the secret key for decrypting the protected content). By these means only the valid header/wrapper can be associated with the encrypted file. Removal of this wrapper will prevent a system from recognising the content, and therefore the content will not be decrypted.

From now on in our described solution we assume that any corresponding electronic licence—if applicable—that specifies the use of the protected content and includes the decryption key is distributed as part of the wrapper. However, as we have discussed above, other approaches are possible where the licence is stored separately on the token or may be accessed via a separate machine.

An agent acting on behalf of the user—for example, that automatically applies a default privacy policy of the user in order to determine what type of privacy policies should apply to that particular data or an existing wrapped entity and then wrap the data or entity accordingly—could reside on the user's token, given enough space, or else be on the user's trusted computer and used to produce the final compound wrapper there that is then loaded onto the token for future use.

Proof that a platform is a genuine Trusted Platform is provided by cryptographic attestation identities. Attestation identities (also called ‘pseudonymous identities’) prove that they correspond to a Trusted Platform and a specific identity always identifies the same platform. Key features of this TCPA mechanism are:
The TPM has control over multiple pseudonymous attestation identities
A TPM attestation identity does not contain any owner/user related information: it is a platform identity to attest to platform properties
A TPM will only use attestation identities to prove to a third party that it is a genuine (TCPA-conformant) TPM

By means of a challenge to the platform from the trusted device, the user can see if the platform is a genuine trusted platform. Furthermore, by getting the trusted device to check the PCR values and log against published integrity metrics, it is possible for the user to see whether the platform is in a trustworthy state and whether genuine copies of the secure loader, trusted executor and trusted application policy are loaded onto that platform.

Only if the user is satisfied as to the trustworthiness of the platform in this way does the user go ahead and carry out the transaction, run the application, print the document, etc. The label and associated policies will ensure that the user's data is treated in the manner that the user would expect, in accordance with their privacy policy.

There are three main options:
(a) The compound wrapper is pre-stored on a platform, with credentials for usage provided by the trusted device/token
(b) The compound wrapper is downloaded to order on a platform, using credentials and specification provided by the trusted device/token
(c) The compound wrapper is stored on the trusted device, and copied to a platform when access is required

A similar mechanism may be used for protection of private information in all of these cases (see below).

It is important to ensure that this mechanism cannot be circumvented. TCPA is used to check the integrity of computer platforms and their installed software, as well as for protection of encryption keys. The software wrappers can be protected by the TPM both while not being used and while executing, by means of the integrity checking process, preferably being stored, at least in part, within the TPM. In addition, the software wrappers can utilize TCPA protected storage mechanisms to check that the platform environment is in a suitable state before content is released.

An analogous approach may be used with several other types of Trusted Platform, and not necessarily just those compliant with the TCPA specification.

FIG. 1 illustrates the general process where a trusted computing device 10 is used in combination with a TPM 12 on a platform 14 for enhanced data protection, corresponding to case (a) above.

The process consists of the following steps:
1. There is mutual authentication between the Platform's Trusted Platform Module (TPM) 12 and Trusted Computing Device (TD) 10.
2. The Trusted Computing Device challenges the TPM 12 to obtain integrity metrics relating to the Trusted Platform 14, as booted up on the platform.
3. If the TD 10 is not satisfied as to the suitability of the platform 14 (which may include checking higher-level information such as the privacy policies associated with the owners of that platform), the protocol will stop.
4. If the TD 10 is satisfied as to the suitability of the platform 14, the TD 10 will then transfer onto the platform 14 the private information such as user ID and credentials wrapped using software wrapper technology to include appropriate label and user specified flow policy.
5. Once the data is unwrapped the label will stay permanently associated with the transferred data, and the OS will enforce corresponding flow policy such as prohibiting sensitive data from being displayed on the screen, or sent to other machines over a network.
6. When the communications link is broken between the TPM 12 and TD 10, or the session finishes, the label may specify that the TPM 12 should delete the user ID from its memory, or that other sensitive information relating to the user (e.g. contents of documents or email, credit card details, address, history of transactions etc.) should be removed.
   Special Case: Self-Destructing Data.

There is a further mechanism by which mobile users' data can be protected against unauthorised use: the data could be wrapped in a wrapper that specifies the circumstances in which that data should be deleted by the OS or otherwise destroyed or made unusable and unreadable. Such ‘self-destruction’ could be triggered either by the platform or user attempting to use it in an unauthorized manner and/or deletion being triggered after a session finishes, after a given number of uses, etc. For example, an application that is a sub-case of this would be that data could be printed only the number of times allowed by copyright law and thereafter only be read on-screen.

Maintaining Anonymity Using a Combination of TCPA and Attribute Certificates.

In order to enhance privacy it is preferable if digital pseudonyms can be used to authenticate the user rather than real identities. Digital pseudonyms can be public keys for testing digital signatures where the holder of the pseudonym can prove holdership by forming a digital signature using the corresponding private key. Such keys could be bound to attributes within digital certificates to form attribute certificates. Thus, privileges, authority or attributes (which X.509 defines as “information of any type”) may be directly associated with a public key, without identifying the associated person or thing.

In addition to the described components, access control mechanisms can also be implemented within the client platform to authenticate different users using the same machine, and to associate different flow control policies with the same data based on user identities. Optionally, certificates referring to TCPA identities and containing attributes within accepted fields could be used in combination with policies or attributes being specified within the label or its associated database, to allow for example people with a given role or rank to perform more sensitive operations than those of more restricted or junior rank. Alternatively, ‘revised’ TCPA certificates could be formed that directly contain such attributes, certified by the Privacy-CA or by another Trusted Third Party. These certificates would typically be stored on the trusted device and made available to the platform in order to allow appropriate access. Thus, using a combination of TCPA attestation identities and attribute certificates, it is possible to implement role-based or attribute-based access within the system described above without having to name the individual concerned. For example, a memo could be wrapped to include the label and policies specifying that only company employees can read it, or photos could be wrapped to include policies that would only allow access to selected family and friends. This would avoid certain types of sensitive information (namely, identity information that identifies the user) having to be transferred from the token to the platform. Again, to cut down on correlation of such pseudonyms to form behaviour profiles, as an added protection measure the pseudonym information could be deleted after the session finished by the TPM, in an analogous manner to that described above.

Annex 1

The present invention relates to data handling apparatus and methods, to computer programs for implementing such methods and to computing platforms configured to operate according to such methods.

Data management is increasingly important as widespread access to public computer networks facilitates distribution of data. Distribution of data over public computer networks may be undesirable when the data in question comprises sensitive, confidential, copyright or other similar information.

A computer operating system can typically monitor input of data to a process or output of data by a process and apply appropriate management restrictions to these operations. Exemplary restrictions may prevent write operations to a public network, or to external memory devices for data having certain identifiable characteristics. However, manipulation of data within a process can not be monitored by the operating system. Such manipulation may modify the identifiable characteristics of data, and thus prevent the operating system from carrying out effective data management.

Particular problems arise when different types of data are assigned different levels of restriction, and processes involving data from different levels of restriction are run alongside one another. An operating system cannot guarantee that the different types of data have not been mixed. To maintain a desired level-of restriction for the most restricted data in these circumstances, this level of restriction must be applied to all data involved in the processes. Consequently, data can only be upgraded to more restricted levels, leading to a system in which only highly trusted users/systems are allowed access to any data.

In prior art systems, security policies are applied at the application level, thus meaning that each application requires a new security policy module dedicated to it.

It is an aim of preferred embodiments of the present invention to overcome at least some of the problems associated with the prior art, whether identified herein, or otherwise.

According to the present invention in a first aspect, there is provided a data handling apparatus for a computer platform using an operating system, the apparatus comprising a system call monitor for detecting predetermined system calls, and means for applying a data handling policy to the system call upon a predetermined system call being detected.

Using such an apparatus, because the security policy determination is initiated at the operating system level by monitoring system calls, it can be made application independent. So, for instance, on a given platform it would not matter which e-mail application is being used, the data handling apparatus could control data usage.

Suitably, in which the policy is to require the encryption of at least some of the data.

Suitably, a policy interpreter in its application of the policy automatically encrypts the at least some of the data.

Suitably, predetermined system calls are those involving the transmission of data externally of the computing platform.

Suitably, the means for applying a data handling policy comprises a tag determiner for determining any security tags associated with data handled by the system call, and a policy interpreter for determining a policy according to any such tags and for applying the policy.

Suitably, the policy interpreter is configured to use the intended destination of the data as a factor in determining the policy for the data.

Suitably, the policy interpreter comprises a policy database including tag policies and a policy reconciler for generating a composite policy from the tag policies relevant to the data.

Suitably, the computing platform comprises a data management unit, the data management unit arranged to associate data management information with data input to a process, and regulate operating system operations involving the data according to the data management information.

Suitably, the computing platform further comprises a memory space, and is arranged to load the process into the memory space and run the process under the control of the data management unit.

Suitably, the data management information is associated with at least one data sub-unit as data is input to a process from a data unit comprising a plurality of sub-units.

Suitably, data management information is associated with each independently addressable data unit.

Suitably, the data management unit comprises part of an operating system kernel space.

Suitably, the operating system kernel space comprises a tagging driver arranged to control loading of a supervisor code into the memory space with the process.

Suitably, the supervisor code controls the process at run time to administer the operating system data management unit.

Suitably, the supervisor code is arranged to analyse instructions of the process to identify operations involving the data, and, provide instructions relating to the data management information with the operations involving the data.

Suitably, the memory space further comprises a data management information area under control of the supervisor code arranged to store the data management information.

Suitably, the data management unit comprises a data filter to identify data management information associated with data that is to be read into the memory space.

Suitably, the data management unit further comprises a tag management module arranged to allow a user to specify data management information to be associated with data.

Suitably, the data management unit comprises a tag propagation module arranged to maintain an association with the data that has been read into the process and the data management information associated therewith.

Suitably, the tag propagation module is arranged to maintain an association between an output of operations carried out within the process and the data management information associated with the data involved in the operations.

Suitably, the tag propagation module comprises state machine automatons arranged to maintain an association between an output of operations carried out within the process and the data management information associated with the data involved in the operations.

According to the present invention in a second aspect, there is provided a data handling method for a computer platform using an operating system, the method comprising the steps of: detecting predetermined system calls, and applying a data handling policy to the system call upon a predetermined system call being detected.

Suitably, the policy is to require the encryption of at least some of the data.

Suitably, in its application of the policy at least some of the data is automatically encrypted.

Suitably, predetermined system calls are those involving the transmission of data externally of the computing platform.

Suitably, the method includes the steps of: determining any security tags associated with data handled by the system call, determining a policy according to any such tags and applying the policy.

Suitably, a composite policy is generated from the tag policies relevant to the data.

Suitably, the intended destination of the data is used as a factor in determining the policy for the data.

Suitably, the method further comprises the steps of: (a) associating data management information with data input to a process; and (b) regulating operating system operations involving the data according to the data management information.

Suitably, supervisor code administers the method by controlling the process at run time.

Suitably, the step (a) comprises associating data management information with data as the data is read into a memory space.

Suitably, the step (a) comprises associating data management information with at least one data sub-unit as data is read into a memory space from a data unit comprising a plurality of data sub-units.

Suitably, the step (a) comprises associating data management information with each independently addressable data unit that is read into the memory space.

Suitably, the data management information is written to a, data management memory space under control of the supervisor code.

Suitably, the supervisor code comprises state machine automatons arranged to control the writing of data management information to the data management memory space.

Suitably, the step (b) comprises sub-steps (b1) identifying an operation involving the data; (b2) if the operation involves the data and is carried out within the process, maintaining an association between an output of the operation and the data management information; and (b3) if the operation involving the data includes a write operation to a location external to the process, selectively performing the operation dependent on the data management information.

Suitably, the step (b1) comprises: analysing process instructions to identify operations involving the data; and, providing instructions relating to the data management information with the operations involving the data.

Suitably, the process instructions are analysed as blocks, each block defined by operations up to a terminating condition.

According to the present invention in a third aspect, there is provided a computer program for controlling a computing platform to operate in accordance with the second aspect of the invention.

According to the present invention in a fourth aspect, there is provided a computer platform configured to operate according with the second aspect of the invention.

For a better understanding of the invention, and to show how embodiments of the same may be carried into effect, reference will now be made, by way of example, to the accompanying diagrammatic drawings in which:

FIG. 1 shows a computing platform for computer operating system data management according to the present invention;

FIG. 2 shows a first operating system data management architecture suitable for use in the computing platform of FIG. 1;

FIG. 3 shows a second operating system data management architecture suitable for use in the computing platform of FIG. 1; and

FIG. 4 shows a flow diagram comprising steps involved in operation of the above described figures;

FIG. 5 shows a flow diagram comprising further steps involved as part of the FIG. 4 operation;

FIG. 6 shows a data handling apparatus according to the present invention;

FIG. 7 shows a functional flow diagram of a method of operation of the apparatus of FIG. 6; and

FIG. 8 shows a functional flow diagram of part of the method of FIG. 7.

Data management in the form of data flow control can offer a high degree of security for identifiable data. Permitted operations for identifiable data form a security policy for that data. However, security of data management systems based on data flow control is compromised if applications involved in data processing can not be trusted to enforce the security policies for all data units and sub-units to which the applications have access. In this document, the term “process” relates to a computing process. Typically, a computing process comprises the sequence of states run through by software as that software is executed.

FIG. 1 shows a computing platform 1 for computer operating system data management comprising, a processor 5, a memory space 10, an OS kernel space 20 comprising a data management unit 21 and a disk 30. The memory space 10 comprises an area of memory that can be addressed by 200310956-1 GB 42 user applications. The processor 5 is coupled to the memory space 10 and the OS kernel space 20 by a bus 6. In use, the computing platform 1 loads a process to be run on the processor 5 from the disk 30 into the memory space 10. It will be appreciated that the process to be run on the processor 5 could be loaded from other locations. The process is run on the processor under the control of the data management unit 21 such that operations involving data read into the memory space 10 by the process are regulated by the data management unit 21. The data management unit 21 regulates operations involving the data according to data management information associated with the data as it is read into the memory space 10.

The data management unit 21 propagates the data management information around the memory space 10 as process operations involving that data are carried out, and prevents the data management information from being read or written over by other operations. The data management unit includes a set of allowable operations for data having particular types of data management information therewith. By inspecting the, data management information associated with a particular piece of data, the data management unit 21 can establish whether a desired operation is allowed for that data, and regulate the process operations accordingly.

FIG. 2 shows an example operating system data management architecture comprising an OS kernel space and a memory space suitable for use in the computing platform of FIG. 1. The example architecture of FIG. 2 enables regulation of operations involving data read into a memory space by enforcing data flow control on applications using that data. The example architecture of FIG. 2 relates to the Windows NT operating system. Windows NT is a registered trade mark of Microsoft Corporation.

FIG. 2 shows a memory space comprising a user space 100 and an OS kernel space 200. The-user space 100 comprises application memory spaces 110A, 110B, supervisor code 120A, 120B, and a tag table 130. The OS kernel space 200 comprises a standard NT kernel 250, file system driver 202 and storage device drivers 203. The OS kernel space 200 further comprises a tagging driver 210, a tag propagation module 220, and a tag management module 230 and a data filter 240.

When an application is to be run in the user space 100, information comprising the application code along with any required function libraries, application data etc. is loaded into a block of user memory space comprising the application memory space 110 under the control of the NT kernel 250. The tagging driver 210 further appends supervisor code to the application memory space 110 and sets aside a memory area for data management information. This memory area comprises the tag table 130.

In preference to allowing the NT kernel 250 to run the application code, the tagging driver 210 receives a code execution notification from the NT kernel 210 and runs the supervisor code 120

When run, the supervisor code 120 scans the application code starting from a first instruction of the application code, and continues through the instructions of the application code until a terminating condition is reached.

A terminating condition comprises an instruction that causes a change in execution flow of the application instructions., Example terminating conditions include jumps to a subroutines, interrupts etc. A portion of the application code between terminating conditions comprises a block of code.

The block of code is disassembled, and data management instructions are provided for any instructions comprising data read/writes to the memory, disk, registers or other functional units such as logic units, or to other input/output (I/O) devices. The data management instructions may include the original instruction that prompted provision of the data management instructions, along with additional instructions relating to data management. Once a block of the application code has been scanned and modified, the modified code can be executed. The scanning process is then repeated, starting with the first instruction of the next block.

At a first system call of the application code relating to a particular piece of data, typically a read instruction, the first data management instruction associates data management information with the data. The data management information comprises a tag held in the tag table 130. The tag table 130 comprises a data management information memory area which can only be accessed by the supervisor code 120. Preferably, a tag is applied to each independently addressable unit of data—normally each byte of data. By applying a tag to each independently addressable piece of data all useable data is tagged, and, maximum flexibility regarding the association of data with a tag is maintained. A tag may preferably comprise a byte or other data unit.

A tag identifies a data management policy to be applied to the data associated with that tag. Different data management policies may specify a number of rules to be enforced in relation to data under that data management policy, for example, “data under this policy may not be written to a public network”, or “data under this policy may only be operated on in a trusted environment”. When independently addressable data units have their own tags it becomes possible for larger data structures such as e.g. files to comprise a number of independently addressable data units having a number of different tags. This ensures the correct policy can be associated with a particular data unit irrespective of its location or association with other data in a memory structure, file structure or other data structure. The data management policy to be applied to data, and hence the tag, can be established in a number of ways.

(1) Data may already have a predetermined data management policy applied to it, and hence be associated with a pre-existing tag. When the NT kernel 250 makes a system call involving a piece of data, the data filter 240 checks for a pre-existing tag associated with that data, and if a pre-existing tag is present notifies the tag propagation module 220 to include the tag in the tag table 130, and to maintain the association of the tag with the data. Any tag associated with the data is maintained, and the data keeps its existing data management policy.

If there is no tag associated with the data, the following tag association methods can be used.

(2) Data read from a specific data source can have a predetermined data management policy corresponding to that data source applied to it. The data filter 240 checks for a data management policy corresponding to the specific data source, and if a predetermined policy does apply to data from that source notifies the tag propagation module 220 to include the corresponding tag in the tag table 130 and associate the tag with the data. For example, all data received over a private network from a trusted party can be associated with a tag indicative of the security status of the trusted party.

(3) When data has no pre-existing tag, and no predetermined data management policy applies to the data source from which the data originates, the tag management module 230 initiates an operating system function that allows a user to directly specify a desired data management policy for the data. The desired data management policy specified by the user determines the tag associated with the data. To ensure that the operating system function is authentic and not subject to subversion, it is desired that the operating system function of the tag management module 230 is trusted. This trust can be achieved and demonstrated to a user in a number of ways, as will be appreciated by the skilled person.

(4) Alternatively, when data has no pre-existing tag, and no predetermined data management policy applies to the data source from which the data originates a default tag can be applied to the data.

Data management instructions are provided for subsequent instructions relating to internal processing of the tagged data. The data management instructions cause the tag propagation module 220 to maintain the association between the data and tag applied to it. Again, the data management instructions may include the instructions relating to internal processing of the data along with additional data management instructions. If the data is modified, e.g. by a logical or other operations, the relevant tag is associated with the modified data. Data management instructions for maintaining the association of tags with data as that data is manipulated and moved can be implemented using relatively simple state machine automatons. These automatons operate at the machine code level to effectively enforce the association and propagation of tags according to simple rules. For example, if data is moved the tag associated with the data at the move destination should be the same as the tag associated with the data before the move. In this simple example, any tag associated with the data at the move destination can be overwritten by the tag associated with the incoming data. Other automatons can be used to combine tags, swap tags, extend tags to other data, leave tags unchanged etc. dependent on the existing data tag(s) and type of operation to be carried out on the data.

The supervisor code 120 manages the tags in the tag table. A simple form of tag management comprises providing a data tag table that is large enough to accommodate a tag for each piece of tagged data. This results in a one-to-one relationship between the data in the application memory space 110, and the data tags in the tag table, and a consequent doubling of the overall memory space required to run the application. However, memory is relatively cheap, and the one to one relationship enables simple functions to be used to associate the data with the relevant tag. As an alternative, different data structures can be envisaged for the data management information area, for example, a tag table can identify groups of data having a particular tag type. This may be advantageous when a file of data all associated with a single tag is involved in an operation. When more than one application is loaded in the user space 100, as shown in FIG. 2 with the two application memory spaces 110A, 110B, a shared tag table 130 can be used. As already mentioned, different tags can be applied to a separate data units within a file or other data structure. This allows an improved flexibility in subsequent manipulation of the data structure ensuring the appropriate policy is applied to the separate data units.

Data management instructions are also provided for instructions relating to writing of data outside the process. The data management instructions may include the instructions relating to writing of data outside the process along with other data management instructions. In this case, the data management instructions prompt the supervisor code 120 to notify the tag propagation module 220 of the tag associated with the data to be written. The system call to the NT kernel 250 is received by the data filter. 240. The data filter 240 queries the allowability of the requested operation with the tag propagation module 220 to verify the tag associated with the data to be written, and check that the data management policy identified by the tag allows the desired write to be performed with the data in question. If the desired write is within the security policy of the data in question, it is performed, with the data filter 240 controlling the file system driver 202 to ensure that the storage device drivers 203 to enforce the persistence of the tags with the stored data. If the data is not permitted to be written as requested, the write operation is blocked. Blocking may comprise writing random bits to the requested location, writing a string of zeros or ones to the requested location, leaving the requested location unaltered, or encrypting the data before writing.

A second example operating system data management architecture suitable for use in the computing platform of FIG. 1 is shown in FIG. 3. The example operating system data management architecture of FIG. 3 relates to the Linux operating system.

FIG. 3 shows a user space 100 and an OS kernel space 200. The user space 100 comprises application memory spaces 110A, 110B, supervisor code 120A, 120B, and a tag table 130. The OS kernel space 200 comprises a tag propagation module 220, a tag management module 230, along with a Linux kernel 260 comprising an executable loader module 261, a process management module 262, a network support module 263 and a file system support module 264.

As the Linux operating system is open source, a number of the functions required to implement the data management system can be incorporated into the existing functional blocks of the kernel. In the example architectures of

FIG. 3, the executable loader module 261, the process management module 262, the network support module 263 and the file system support module 264 are be modified versions of those included in a standard Linux kernel, as will be described below.

As before, the supervisor code 120 controls system calls, handles memory space tag propagation, and instructs policy checks in the OS kernel space 200 when required. Also as before, the tag propagation module 220 maintains policy information relating to allowable operations within the policies, and the tag management module 230 provides an administrative interface comprising an operating system function that allows a user to directly specify a desired data management policy for the data.

The operation of the Linux kernel 260 allows the data management architectures shown to carry out data flow control. The executable loader 261 includes a tagging driver that ensures applications are run under the control of the supervisor code 120. The process management module 262 carries out process management control to maintain the processor running the application or applications in a suitable state to enable tag association, monitoring and propagation. The network support module 263 enables the propagation of tags with data, across a network, and the file system support module 264 enables the propagation of tags with data on disk. The network support module 263 and the file system support module 264 together provide the functionality of the data filter of FIG. 2. Again, state machine based automation can be used to perform basic tag association, monitoring and propagation functions at a machine code level.

The modifications to the executable loader module 261, the process management module 262, the network support module 263 and the file system support module 264 can be easily implemented with suitable hooks.

FIG. 4 shows a flow diagram outlining basic steps in an example method of operating system data management.

The method comprises a first step 300 of associating data management information with data input to a process; and a second step 310 of regulating operations involving the data input to the process in the first step 300 according to the data management information associated with the data in the first step 300. The basic first and second steps 300, 310 are further expanded upon in the flow diagram of FIG. 5.

FIG. 5 shows a flow diagram outlining further steps in an example method of operating system data management.

The method of FIG. 5 starts with an “external operation?” decision 312. If data on which the method is performed is read into memory space associated with a process from a location external to, the memory space associated with the process, the outcome of the “external operation?” decision 312 is YES. Furthermore, if the data within the process is to be written to an external location, the outcome of the “external operation?” decision 312 is also YES. Following a positive decision at the “external operation?” decision, the method moves to the “tag present?” decision 314. Operations involving data within the process result in a negative outcome at the “external operation?” decision 312.

At the “tag present?” decision 314, it is determined whether the data involved in the operation has data management information associated with it. If the data has no data management information associated with it, the association step 300 is performed, and the method returns to the “external operation?” decision 312.

In the association step 300, data management information is associated with the data in question. This association can be carried out by any of the methods described earlier, or by other suitable methods.

Following a positive decision at the “tag present?” decision 314, the method moves to the “operation allowed?” decision 316. At this decision, the data management information associated with the data is examined, and its compatibility with the specified external operation identified in the “external operation?” decision 312 is established.

If the data management information is compatible with the external operation, it is carried out in the execution step 318. Following the execution step 318, the method returns to the “external operation?” decision 312. Alternatively, if the data management information is not compatible with the external operation, it is blocked in the blocking step 318. Blocking in step 318 can comprise any of the methods described earlier, or by other suitable methods.

Any operations identified at the “external operation?” decision 312 as internal operations are carried out, with association of the data involved in the operation with the relevant data management information maintained in the tag propagation step 313.

Including the data management functionality with an operating system provides a first level of security, as operating system operation should be relatively free from security threatening bugs compared to either commercial or open source application software. Furthermore, if the operating system allows trusted operation after a secure boots, for example as provided for by the Trusted Computing Platform Alliance (TCPA) standard, the data management functionality can also form part of the trusted system. This enables the data management functions to also form part of the trusted system, enabling. e.g. digital rights management or other secrecy conditions to be enforced on data.

It is possible that the computing platform for operating system data management could refuse to open or write data with a pre-existing tag unless the computing platform is running in a trusted mode, adding to the enforceability of data flow control under the data management system. This is particularly useful when encrypted data is moved between trusted computing platforms over a public network.

An operating system data management method, and a computing platform for operating system data management have been described. The data management method and computing platform allow a supervisor code to monitor data flow into and out of an application using data management information. As data is used within an application process, the data management information is propagated with the data. This allows the supervisor code to ensure that only external write operations which are compatible with a data management policy for the data are performed. The data flow monitoring and enforcement enabled by the data management method and computing platform facilitate the construction of systems that support digital rights management and other data privacy-functions, but avoid the problems associated with system wide approaches to data flow control systems. In particular, the granularity provided by associating data management information with data units that are individually addressable rather than with a data structure such as a file of which the individually addressable data units are part offers improved flexibility in how security is enforced. The method and computing platform described do not require source code modification of application and subsequent recompilation. Furthermore, the method and system described can easily be retrospectively implemented in a variety of known operating systems, for example Windows NT and Linux as show herein.

The functionality described above can also be implemented on a virtual machine.

There will now be described a method and apparatus for handling tagged data. These are applicable to the data tagged and propagated as described above as well as to data tagged in other ways, for instance at the file level (i.e. all data in a file having the same tag).

FIG. 6 of shows a data handling apparatus 400 forming a part of the computing platform 1 shown in FIG. 1. The data handling apparatus 400 comprises a system call monitor 402, a tag determiner 404 and a policy interpreter 406. The policy interpreter 406 comprises a policy database 408 and a policy reconciler 410. Also shown in FIG. 6 are external devices indicated generally at 412, which can be local external devices 414 such as printers, CD writers, floppy disk drives, etc or any device on a network (which can be a local network, a wide area network or a connection to the Internet), such as a printer, another computer, CD writer, etc. The data handling apparatus 400 can be embodied in hardware or software, and in the latter case may be a separate application or more preferably runs at an operating system level.

Operation of the apparatus shown in FIG. 6 is explained with reference to FIG. 7 which shows a functional flow diagram thereof.

In step 450 the data handling apparatus 400 runs on a computing platform 1 and the system call monitor 402 checks each system call at the kernel layer of the operating system to determine whether it is a system call in relation to which the data handling apparatus 400 is configured to control. Typically the controlled system calls are those involving writes of data to devices (which include writes to network sockets) so that the transfer of data externally of the operating system and computing platform memory can be controlled. The system call monitor 402 implemented at the kernel level keeps track of new file descriptors being created during the process execution that refer to controlled external devices and network sockets. The system call monitor 402 also monitors all system calls where data is written to these file descriptors. Whenever a system call is intercepted that causes data write or send, the process is stopped and both the data and the file descriptor that this data is being written/sent to are examined. The system call monitor 402 has a list of predetermined system calls that should always-be denied or permitted. If the intercepted-system call falls into this category the system call monitor uses this fast method to permit or deny a system call. If the fast method cannot be used, the system call monitor needs to ask the policy interpreter 406 in user space for a policy decision. Thus either the system call monitor 402 or the tag determiner 404 and policy interpreter 406 can be a means for applying a data handling policy to the system call upon a predetermined system call being detected

Once a predetermined system call has been detected by system call monitor 402, then in step 452 the tag determiner 404 determines what security tag or tags are associated with the corresponding operation. For the purpose of this explanation of an embodiment of the present invention, it is assumed the system call is of data from a file to a networked device. Using the data tagging described above, a plurality of tags will apply. Using other tagging techniques there may only be one tag associated with a file. For this embodiment it is assumed that there are several tags associated with the data. The tags associated with the data relevant to the action of the system call are communicated to the policy interpreter 406 in step 454.

In step 456, the policy interpreter 406 determines the policy to be applied to the data. Referring to FIG. 8, the sub-steps of step 456 are shown in more detail. In step 458 a policy for each tag is looked up from the policy database 408. Since the so determined policies may be inconsistent, the resultant policies are supplied to policy reconciler 410, which in step 460 carries out a policy reconciliation to generate a policy to apply to the data. The nature of the policy reconciliation is a matter of design choice for a person skilled in the art. At its simplest policy reconciliation will provide that the most restrictive policy derived from all restrictions and requirements of the policies associated with the tags applies, effectively ANDing all the policies. However, many alternatives exist. The policy reconciler may make policy determinations based on the intended destination of the relevant data, which is known from information provided by the system call monitor 402.

Once a reconciled policy has been determined by policy reconciler 410, this is the output from policy interpreter 406 that is returned to system call monitor 402. The system call monitor allows the stopped process to continue execution after it applies the result to the operation in question in step 462 (FIG. 7).

Generally there will be three policy applications. The first will be to permit the operation. The second will be to block the operation. The third will be to permit the operation but to vary it in some way. The main variation is the encryption of the data being transmitted for additional security.

In any data transmission, tags may be propagated as described above.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

Annex 2

The present invention relates to methods of computer operating system data management, to computing platforms for computer operating system data management, to computer programs including instructions configured to enable computer operating system data management, to computer operating systems arranged to perform operating system data management, to a computer operating system data management method, and, to computer operating system data management apparatus.

Data management is increasingly important as widespread access to public computer networks facilitates distribution of data. Distribution of data over public computer networks may be undesirable when the data in question comprises sensitive, confidential, copyright or other similar information.

A computer operating system can typically monitor input of data to a process or output of data by a process and apply appropriate management restrictions to these operations. Exemplary restrictions may prevent write operations to a public network, or to external memory devices for data having certain identifiable characteristics. However, manipulation of data within a process can not be monitored by the operating system. Such manipulation may modify the identifiable characteristics of data, and thus prevent the operating system from carrying out effective data management.

Particular problems arise when different types of data are assigned different levels of restriction, and processes involving data from different levels of restriction are run alongside one another. An operating system cannot guarantee that the different types of data have not been mixed. To maintain a desired level of restriction for the most restricted data in these circumstances, this level of restriction must be applied to all data involved in the processes. Consequently, data can only be upgraded to more restricted levels, leading to a system in which only highly trusted users/systems are allowed access to any data.

It is an aim of preferred embodiments of the present invention to overcome at least some of the problems associated with the prior art, whether identified herein, or otherwise.

According to a first aspect of the present invention there is provided a method of computer operating system data management, the method comprising the steps of: (a) associating data management information with data input to a process; and (b) regulating operating system operations involving the data according to the data management information.

By associating data management information at the operating system level greater security and flexibility is obtained; features that are often mutually exclusive.

Suitably, supervisor code administers the method by controlling the process at run time.

Suitably, the step (a) comprises associating data management information with data as the data is read into a memory space. Suitably, the step (a) comprises associating data management information with at least one data sub-unit as data is read into a memory space from a data unit comprising a plurality of data sub-units. Suitably, the step (a) comprises associating data management information with each independently addressable data unit that is read into the memory space. Suitably, the data management information is written to a data management memory space under control of the supervisor code. Suitably, the supervisor code comprises state machine automatons arranged to control the writing of data management information to the data management memory space.

Suitably, the step (b) comprises sub-steps (b1) identifying an operation involving the data; (b2) if the operation involves the data and is carried out within the process, maintaining an association between an output of the operation and the data management information; and (b3) if the operation involving the data includes a write operation to a location external to the process, selectively performing the operation dependent on the data management information.

Suitably, the step (b1) comprises: analysing process instructions to identify operations involving the data; and, providing instructions relating to the data management information with the operations involving, the data. Suitably, the process instructions are analysed as blocks, each block defined by operations up to a terminating condition.

According to a second aspect of the present invention there is provided a computing platform for computer operating system data management, the computing platform comprising a data management unit, the data management unit arranged to associate data management information with data input to a process, and regulate operating system operations involving the data according to the data management information.

Suitably, the computing platform further comprises a memory space, and is arranged to load the process into the memory space and run the process under the control of the data management unit.

Suitably, the data management information is associated with at least one data sub-unit as data is input to a process from a data unit comprising a plurality of sub-units.

Suitably, data management information is associated with each independently addressable data unit.

Suitably, the data management unit comprises part of an operating system kernel space. Suitably the operating system kernel space comprises a tagging driver arranged to control loading of a supervisor code into the memory space with the process.

Suitably the supervisor code controls the process at run time to administer the operating system data management unit. Suitably, the supervisor code is arranged to analyse instructions of the process to identify operations involving the data, and, provide instructions relating to the data management information with the operations involving the data.

Suitably, the memory space further comprises a data management information area under control of the supervisor code arranged to store the data management information.

Suitably, the data management unit comprises a data filter to identify data management information associated with data that is to be read into the memory space. The data filter may associate data management information with data read into the memory space from predetermined sources. The data filter may associate default data management information with data read into the memory space. Suitably, the data management unit further comprises a tag management module arranged to allow a user to specify data management information to be associated with data.

Suitably, the data management unit comprises a tag propagation module arranged to maintain an association with the data that has been read into the process and the data management information associated therewith. Suitably, the tag propagation module is arranged to maintain an association between an output of operations carried out within the process and the data management information associated with the data involved in the operations.

Suitably, the tag propagation module comprises state machine automatons arranged to maintain an association between an output of operations carried out within the process and the data management information associated with the data involved in the operations.

According to a third aspect of the present invention there is provided a computer operating system data management method comprising the step of: identifying data having data management information associated therewith when the data is to be read into a memory space.

Suitably, the method further comprises the step of associating data management information with the data if the data is identified as having no data management information associated therewith.

Suitably, the data management information associated with data is read into the memory space with the data.

Suitably, the method further comprises the step of maintaining an association between the data and the data management information when the data is involved in operations within the process, and associating data management information with other data resulting from operations involving the data.

Suitably, the step of maintaining an association between the data and the data management information when the data is involved in operations within the process, and associating data management information with other data resulting from operations involving the data is carried out according to state machine automatons.

Suitably, the method further comprises the step of examining the data management information when the data is to be involved in an operation external to the process, and allowing the operation if it is compatible with the data management information. Suitably, the operation is blocked if it is not compatible with the data management information.

Suitably, an operation external to the process may be compatible with the data management information subject Lo including the associated data management information with an output of the operation.

Suitably, the data management information identifies a set of permitted operations.

According to a fourth aspect of the present invention there is provided a computer operating system data management apparatus arranged to identify data having data management information associated therewith when data is read into a memory space.

Suitably, the data filter comprises part of a data management unit, and is arranged to associate data management information with the data if the data is identified as having no data management information associated therewith.

Suitably, the data management unit is arranged read the data management information associated with data is into the memory space with the data.

Suitably, the data management unit comprises a tag propagation module arranged to maintain an association between the data and the data management information when the data is involved in operations within the process, and to associate data management information with other data resulting from operations involving the data.

Suitably, the tag propagation module comprises state machine automatons arranged to maintain an association between the data and the data management information when the data is involved in operations within the process, and to associate data management information with other data resulting from operations involving the data.

Suitably, the tag propagation module is arranged to examine the data management information when the data is to be involved in an operation external to the process, and cause the operation to be allowed if it is compatible with the data management information.

Suitably, the tag propagation module is arranged to cause the operation to be blocked if the operation is not compatible with the data management information.

Suitably, the tag propagation module is arranged to perform the operation external to the process subject to including the associated data management information with an output of the operation.

Suitably, the data management information identifies a set of permitted operations.

According to a fifth aspect of the present invention there is provided a computer program including instructions configured to enable computer operating system data management in accordance with the first aspect of the invention.

According to a sixth aspect of the invention there is provided an operating system comprising an application code modifying unit arranged to perform a method of computer operating system data management in accordance with the first aspect of the invention.

For a better understanding of the invention, and to show how embodiments of the same may be carried into effect, reference will now be made, by way of example, to the accompanying diagrammatic drawings in which:

FIG. 1 shows a computing platform for computer operating system data management according to a first embodiment of the invention;

FIG. 2 shows a first operating system data management architecture suitable for use in the computing platform of FIG. 1;

FIG. 3 shows a second operating system data management architecture suitable for use in the computing platform of FIG. 1; and

FIG. 4 shows a flow diagram comprising steps involved in embodiments of the invention; and

FIG. 5 shows a flow diagram comprising further steps involved in embodiments of the invention.

Data management in the form of data flow control can offer a high degree of security for identifiable data. Permitted operations for identifiable data form a security policy for that data. However, security of data management systems based on data flow control is compromised if applications involved in data processing can not be trusted to enforce the security policies for all data units and sub-units to which the applications have access. In this document, the term “process” relates to a computing process. Typically, a computing process comprises the sequence of states run through by software as that software is executed.

FIG. 1 shows a computing platform 1 for computer operating system data management comprising, a, processor 5, a memory space 10, an OS kernel space 20 comprising a data management unit 21 and a disk 30. The memory space 10 comprises an area of memory that can be addressed by user applications. The processor 5 is coupled to the memory space 10 and the OS kernel space 20 by a bus 6. In use, the computing platform 1 loads a process to be run on the processor 5 from the disk 30 into the memory space 10. It will be appreciated that the process to be run on the processor 5 could be loaded from other locations. The process is run on the processor under the control of the data management unit 21 such that operations involving data read into the memory space 10 by the process are regulated by the data management unit 21. The data management unit 21 regulates operations involving the data according to data management information associated with the data as it is read into the memory space 10.

The data management unit 21 propagates the data management information around the memory space 10 as process operations involving that data are carried out, and prevents the data management information from being read or written over by other operations. The data management unit includes a set of allowable operations for data having particular types of data management information therewith. By inspecting the data management information associated with a particular piece of data, the data management unit 21 can establish whether a desired operation is allowed for that data, and regulate the process operations accordingly.

FIG. 2 shows an example operating system data management architecture comprising an OS kernel space and a memory space suitable for use in the computing platform of FIG. 1. The example architecture of FIG. 2 enables regulation of operations involving data read into a memory space by enforcing data flow control on applications using that data. The example architecture of FIG. 2 relates to the Windows NT operating system. Windows NT is a registered trade mark of Microsoft Corporation.

FIG. 2 shows a memory space comprising a user space 100 and an OS kernel space 200. The user space 100 comprises application memory spaces 110A, 110B, supervisor code 120A, 120B, and a tag table 130. The OS kernel space 200 comprises a standard NT kernel 250, file system driver 202 and storage device drivers 203. The OS kernel space 200 further comprises a tagging driver 210, a tag propagation module 220, and a tag management module 230 and a data filter 240.

When an application is to be run in the user space 100, information comprising the application code along with any required function libraries, application data etc. is loaded into a block of user memory space comprising the application memory space 110 under the control of the NT kernel 250. The tagging driver 210 further appends supervisor code to the application memory space 110 and sets aside a memory area for data management information. This memory area comprises the tag table 130.

In preference to allowing the NT kernel 250 to run the application code, the tagging driver 210 receives a code execution notification from the NT kernel 210 and runs the supervisor code 120

When run, the supervisor code 120 scans the application code starting from a first instruction of the application code, and continues through the instructions of the application code until a terminating condition is reached. A terminating condition comprises an instruction that causes a change in execution flow of the application instructions., Example terminating conditions include jumps to a subroutines, interrupts etc. A portion of the application code between terminating conditions comprises a block of code.

The block of code is disassembled, and data management instructions are provided for any instructions comprising data read/writes to the memory, disk, registers or other functional units such as logic units, or to other input/output (I/O) devices. The data management instructions may include the original instruction that prompted provision of the data management instructions, along with additional instructions relating to data management. Once a block of the application code has been scanned and modified, the modified code can be executed. The scanning process is then repeated, starting with the first instruction of the next block.

At a first system call of the application code relating to a particular piece of data, typically a read instruction, the first data management instruction associates data management information with the data. The data management information comprises a tag held in the tag table 130. The tag table 130 comprises a data management information memory area which can only be accessed by the supervisor code 120. Preferably, a tag is applied to each independently addressable unit of data—normally each byte of data. By applying a tag to each independently addressable piece of data all useable data is tagged, and, maximum flexibility regarding the association of data with a tag is maintained. A tag may preferably comprise a byte or other data unit.

A tag identifies a data management policy to be applied to the data associated with that tag. Different data management policies may specify a number of rules to be enforced in relation to data under that data management policy, for example, “data under this policy may not be written to a public network”, or “data under this policy may only be operated on in a trusted environment”. When independently addressable data units have their own tags it becomes possible for larger data structures such as e.g. files to comprise a number of independently addressable data units having a number of different tags. This ensures the correct policy can be associated with a particular data unit irrespective of its location or association with other data in a memory structure, file structure or other data structure. The data management policy to be applied to data, and hence the tag, can be established in a number of ways.

(1) Data may already have a predetermined data management policy applied to it, and hence be associated with a pre-existing tag. When the NT kernel 250 makes a system call involving a piece of data, the data filter 240 checks for a pre-existing tag associated with that data, and if a pre-existing tag is present notifies the tag propagation module 220 to include the tag in the tag table 130, and to maintain the association of the tag with the data. Any tag associated with the data is maintained, and the data keeps its existing data management policy.

If there is no tag associated-with the data, the following tag association methods can be used.

(2) Data read from a specific data source can have a predetermined data management policy corresponding to that data source applied to it. The data filter 240 checks for a data management policy corresponding to the specific data source, and if a predetermined policy does apply to data from that source notifies the tag propagation module 220 to include the corresponding tag in the tag table 130 and associate the tag with the data. For example, all data received over a private network from a trusted party can be associated with a tag indicative of the security status of the trusted party.

(3) When data has no pre-existing tag, and no predetermined data management policy applies to the data source from which the data originates, the tag management module 230 initiates an operating system function that allows a user to directly specify a desired data management policy for the data. The desired data management policy specified by the user determines the tag associated with the data. To ensure that the operating system function is authentic and not subject to subversion, it is desired that the operating system function of the tag management module 230 is trusted. This trust can be achieved and demonstrated to a user in a number of ways, as will be appreciated by the skilled person.

(4) Alternatively, when data has no pre-existing tag, and no predetermined data management policy applies to the data source from which the data originates a default tag can be applied to the data.

Data management instructions are provided for subsequent instructions relating to internal processing of the tagged data. The data management instructions cause the tag propagation module 220 to maintain the association between the data and tag applied to it. Again, the data management instructions may include the instructions relating to internal processing of the data along with additional data management instructions. If the data is modified, e.g. by a logical or other operations, the relevant tag is associated with the modified data. Data management instructions for maintaining the association of tags with data as that data is manipulated and moved can be implemented using relatively simple state machine automatons. These automatons operate at the machine code level to effectively enforce the association and propagation of tags according to simple rules. For example, if data is moved the tag associated with the data at the move destination should be the same as the tag associated with the data before the move. In this simple example, any tag associated with the data at the move destination can be overwritten by the tag associated with the incoming data. Other automatons can be used to combine tags, swap tags, extend tags to other data, leave tags unchanged etc. dependent on the existing data tag(s) and type of operation to be carried out on the data.

The supervisor code 120 manages the tags in the tag table. A simple form of tag management comprises providing a data tag table that is large enough to accommodate a tag for each piece of tagged data. This results in a one-to-one relationship between the data in the application memory space 110, and the data tags in the tag table, and a consequent doubling of the overall memory space required to run the application. However, memory is relatively cheap, and the one to one relationship enables simple functions to be used to associate the data with the relevant tag. As an alternative, different data structures can be envisaged for the data management information area, for example, a tag table can identify groups of data having a particular tag type. This may be advantageous when a file of data all associated with a single tag is involved in an operation. When more than one application is loaded in the user space 100, as shown in FIG. 2 with the two application memory spaces 110A, 110B, a shared tag table 130 can be used. As already mentioned, different tags can be applied to a separate data units within a file or other data structure. This allows an improved flexibility in subsequent manipulation of the data structure ensuring the appropriate policy is applied to the separate data units.

Data management instructions are also provided for instructions relating to writing of data outside the process. The data management instructions may include the instructions relating to writing of data outside the process along with other data management instructions. In this case, the data management instructions prompt the supervisor code 120 to notify the tag propagation module 220 of the tag associated with the data to be written. The system call to the NT kernel 250 is received by the data filter 240. The data filter 240 queries the allowability of the requested operation with the tag propagation module 220 to verify the tag associated with the data to be written, and check that the data management policy identified by the tag allows the desired write to be performed with the data in question. If the desired write is within the security policy of the data in question, it is performed, with the data filter 240 controlling the file system driver 202 to ensure that the storage device drivers 203 to enforce the persistence of the tags with the stored data. If the data is not permitted to be written as requested, the write operation is blocked. Blocking may comprise writing random bits to the requested location, writing a string of zeros or ones to the requested location, leaving the requested location unaltered, or encrypting the data before writing.

A second example operating system data management architecture suitable for use in the computing platform of FIG. 1 is shown in FIG. 3. The example operating system data management architecture of FIG. 3 relates to the Linux operating system.

FIG. 3 shows a user space 100 and an OS kernel space 200. The user space 100 comprises application memory spaces 110A, 110B, supervisor code 120A, 120B, and a tag table 130. The OS kernel space 200 comprises a tag propagation module 220, a tag management module 230, along with a Linux kernel 260 comprising an executable loader module 261, a process management module 262, a network support module 263 and a file system support module 264.

As the Linux operating system is open source, a number of the functions required to implement the data management system can be incorporated into the existing functional blocks of the kernel. In the example architectures of FIG. 3, the executable loader module 261, the process management module 262, the network support module 263 and the file system support module 264 are be modified versions of those included in a standard Linux kernel, as will be described below.

As before, the supervisor code 120 controls system calls, handles memory space tag propagation, and instructs policy checks in the OS kernel space 200 when required. Also as before, the tag propagation module 220 maintains policy information relating to allowable operations within the policies, and the tag management module 230 provides an administrative interface comprising an operating system function that allows a user to directly specify a desired data management policy for the data.

The operation of the Linux kernel 260 allows the data management architectures shown to carry out data flow control. The executable loader 261 includes a tagging driver that ensures applications are run under the control of the supervisor code 120. The process management module 262 carries out process management control to maintain the processor running the application or applications in a suitable state to enable tag association, monitoring and propagation. The network support module 263 enables the propagation of tags with data across a network, and the file system support module 264 enables the propagation of tags with data on disk. The network support module 263 and the file system support module 264 together provide the functionality of the data filter of FIG. 2. Again, state machine based automation can be used to perform basic tag association, monitoring and propagation functions at a machine code level.

The modifications to the executable loader module 261, the process management module 262, the network support module 263 and the file system support module 264 can be easily implemented with suitable hooks.

FIG. 4 shows a flow diagram outlining basic steps in an example method of operating system data management.

The method comprises a first step 300 of associating data management information with data input to a process; and a second step 310 of regulating operations involving the data input to the process in the first step 300 according to the data management information associated with the data in the first step 300. The basic first and second steps 300,310 are further expanded upon in the flow diagram of FIG. 5.

FIG. 5 shows a flow diagram outlining further steps in an example method of operating system data management.

The method of FIG. 5 starts with an “external operation?” decision 312. If data on which the method is performed is read into memory space associated with a process from a location external to :the memory space associated with the process, the outcome of the “external operation?” decision 312 is YES. Furthermore, if the data within the process is to be written to an external location, the outcome of the “external operation?” decision 312 is also YES. Following a positive decision at the “external operation?” decision, the method moves to the “tag present?” decision 314. Operations involving data within the process result in a negative outcome at the “external operation?” decision 312.

At the “tag present?” decision 314, it is determined whether the data involved in the operation has data management information associated with it. If the data has no data management information associated with it, the association step 300 is performed, and the method returns to the “external operation?” decision 312.

In the association step 300, data management information is associated with the data in question. This association can be carried out by any of the methods described earlier, or by other suitable methods.

Following a positive decision at the “tag present?” decision 314, the method moves to the “operation allowed?” decision 316. At this decision, the data management information associated with the data is examined, and its compatibility with the specified external operation identified in the “external operation?” decision 312 is established.

If the data management information is compatible with the external operation, it is carried out in the execution step 318. Following the execution step 318, the method returns to the “external operation?” decision 312. Alternatively, if the data management information is not compatible with the external operation, it is blocked in the blocking step 318. Blocking in step 318 can comprise any of the methods described earlier, or by other suitable methods.

Any operations identified at the “external operation?” decision 312 as internal operations are carried out, with association of the data involved in the operation with the relevant data management information maintained in the tag propagation step 313.

Including the data management functionality with an operating system provides a first level of security, as operating system operation should be relatively free from security threatening bugs compared to either commercial or open source application software. Furthermore, if the operating system allows trusted operation after a secure boots, for example as provided for by the Trusted Computing Platform Alliance (TCPA) standard, the data management functionality can also form part of the trusted system. This enables the data management functions to also form part of the trusted system, enabling e.g. digital rights management or other secrecy conditions to be enforced on data.

It is possible that the computing platform for operating system data management could refuse to open or write data with a pre-existing tag unless the computing platform is running in a trusted mode, adding to the enforceability of data flow control under the data management system. This is particularly useful when encrypted data is moved between trusted computing platforms over a public network.

An operating system running as a virtual machine using an aspect of the present invention, also falls within its scope.

An operating system data management method and a computing platform for operating system data management have been described. The data management method and computing platform allow a supervisor code to monitor data flow into and out of an application using data management information. As data is used within an application process, the data management information is propagated with the data. This allows the supervisor code to ensure that only external write operations which are compatible with a data management policy for the data are performed. The data flow monitoring and enforcement enabled by the data management method and computing platform facilitate the construction of systems that support digital rights management and other data privacy functions, but avoid the problems associated with system wide approaches to data flow control systems. In particular, the granularity provided by associating data management information with data units that are individually addressable rather than with a data structure such as a file of which the individually addressable data units are part offers improved flexibility in how security is enforced. The method and computing platform described do not require source code modification of application and subsequent recompilation. Furthermore, the method and system described can easily be retrospectively implemented in a variety of known operating systems, for example Windows NT and Linux as show herein.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of protecting a user's data comprises:
a) wrapping data content to be sent to a third party computing platform in a compound software wrapper;
b) interrogating the third party computing platform for compliance with a trusted platform specification;
c) on successful interrogation of the third party computing platform, transmitting the data content wrapped in the compound wrapper to the third party computing platform;
d) unwrapping the compound software wrapper on the third party computing platform;
e) wherein the third party computing platform treats the data content in conformity with a compound policy forming part of the software wrapper which compound policy specifies how the data content may be used.

2. The method as claimed in claim 1, in which at least the compound policy is stored on a security token.

3. The method as claimed in claim 2, in which the security token is a tamper resistant smartcard.

4. The method as claimed in any preceding claim, in which the data content comprises computer files, such as executable codes, including applications, user credentials and/or data files.

5. The method as claimed in any preceding claim, in which the compound policy includes a rights management policy, which specifies terms of purchase of the data content.

6. The method as claimed in any preceding claim, in which the compound policy includes at least one information flow control policy which defines how the data content may be manipulated.

7. The method as claimed in any preceding claim, in which the compound policy includes a user privacy policy which specifies circumstances in which the data content may be used.

8. The method as claimed in claim 7 when dependent on either claim 5 or claim 6, in which the user privacy policy puts constraints on usage of the data content in addition to those as specified in either or both of the rights management policy for the information flow control policy.

9. The method as claimed in any one of claims 6 to 8, in which the information flow control policy specifies whether the data content can be sent from the third party platform, whether it is allowed to leave a trusted area of the third party platform, deleted after a user's session with the third party computing platform has ceased, whether it is allowed to control printing, be displayed on a screen, copied to a recordable medium and/or specify that a user's data must be kept secret.

10. The method as claimed in any one of claims 7 to 9, in which the user privacy policy specifies that the data content must be deleted or made otherwise unusable in the specified circumstances.

11. The method as claimed in any one of claims 7 to 10, in which the compound wrapper has a structure whereby a header precedes the user privacy policy, which precedes a header from a provider of the data content, which precedes encrypted data content.

12. The method as claimed in claim 11, in which the encrypted data content is preceded by an encrypted name of the data content and/or a digital signature by the content provider of a hash of the data content.

13. The method as claimed in any preceding claim, in which after unwrapping of the compound software wrapper, the method includes generating and associating a security label with the data content.

14. The method as claimed in claim 13, in which the label is associated permanently with the data content.

15. The method as claimed in either claim 13 or claim 14, in which the association of the label and data content is enforced by an operating system of the third party platform.

16. The method as claimed in any one of claims 13 to 15, in which the label represents the compound policy/policies.

17. A method of wrapping data content in a compound software wrapper comprises step a) of the first aspect, in which the compound software wrapper includes at least one of a rights management policy, an information flow control policy and a user privacy policy.

18. A method of using data on a third party computing platform comprises steps d) and e) of claim 1.

19. The method as claimed in claim 18, which includes the generation of a label that represents the compound policy, which label is associated with the data content.

20. A compound software wrapper comprises:
a header section relating to the content of the wrapper;
data content;
a key record section;
characterised by including a compound policy including one or more of a rights management policy, an information flow control policy and a user privacy policy.

21. The compound wrapper as claimed in claim 20, in which the key record section includes key records for some or all of the data content.

22. The software wrapper as claimed in claim 20 or claim 19, in which the user privacy policy further restricts the use of the data content allowed by the information flow control policy and/or the rights management policy.

23. A recordable medium carrying a software wrapper according to any one of claims 20 to 22.

24. A recordable medium carrying at least a compound policy as claimed in claim 1.

25. A recordable medium as claimed in claim 24, which is a smartcard.

26. A computer platform operable to produce a compound software wrapper as claimed in any one of claims 20 to 22.

27. A computer program product operable to produce a compound software wrapper as claimed in any one of claims 20 to 22.

28. A computer platform operable to unwrap a compound software wrapper as defined in any one of claims 20 to 22.

29. A method of protecting a user's data substantially as described herein with reference to the accompanying drawings.

30. A computing platform substantially as described herein with reference to the accompanying drawings.
